(19) United States
(12) Patent Application Publication
(10) Pub. No.: US 2026/0233572 A1
(43) Pub. Date: Aug. 13, 2026

(54) Assembly for a Motor Vehicle, In Particular a Battery-Powered Electric Vehicle, Installation Method

(71) Applicant: MAHLE International GmbH, Stuttgart (DE)

(72) Inventors: Gerrit WÖLK (WOELK), Stuttgart (DE); Holger ULRICH, Korntal-Munchingen (DE); Witalie GRAF, Eberdingen (DE)

(21) Appl. No.: 19/535,182

(22) Filed: Feb. 10, 2026

(30) Foreign Application Priority Data
Feb. 11, 2025 (DE) 102025105007.4

(51) Int. Cl. B60H 1/00; B60H 1/06; B60H 1/14

(52) U.S. Cl. CPC B60H 1/00335; B60H 1/00278; B60H 1/00328; B60H 1/00885; B60H 1/06; B60H 1/143; B60H 2001/00307

(57) ABSTRACT

An assembly (1) for a motor vehicle, in particular a battery-powered electric vehicle is provided. The assembly includes a thermal management module with a refrigerant circuit in which there are at least two heat exchangers for exchanging heat between the refrigerant and a separate coolant conducted therethrough, a compressor with a housing for pressurizing the refrigerant, and a mount to which the compressor and the thermal management module are attached, such that the mount, along with the compressor and thermal management module form a structural unit that can be installed in the vehicle.

### CROSS-REFERENCE TO RELATED APPLICATIONS

This application claims priority from German Patent Application No. 102025105007.4, filed on Feb. 11, 2025, the entirety of which is hereby incorporated by reference herein.

The present invention relates to an assembly for a motor vehicle, in particular a battery-powered electric vehicle. The invention also relates to a method for installing such an assembly in a motor vehicle.

Thermal management modules for controlling the temperatures of vehicle components contain a closed refrigerant circuit. There is also a separate coolant circuit. The coolant can be used to control the temperature of various vehicle components and the vehicle interior. The refrigerant circuit is used to control the temperature of the coolant in the coolant circuit, specifically by absorbing heat therefrom. This normally takes place in two heat exchangers in the thermal management module, which are both located in the refrigerant circuit and in the coolant circuit, thus thermally coupling both circuits in the two heat exchangers. This allows heat to be exchanged between the refrigerant and the coolant. It has proven to be advantageous when the closed refrigerant circuit is not connected to the vehicle components that need to be cooled, and also does not pass through the vehicle interior, which is frequently no longer allowed in modern vehicles for safety and legal reasons.

A conventional compressor is usually used to pressurize the refrigerant in the thermal management module refrigerant circuit.

In conventional vehicles, the compressor and thermal management module are normally separate elements that are installed separately. Likewise, the refrigerant circuit is usually filled with refrigerant after installing the thermal management module in the vehicle.

All of this makes installation of the compressor and the thermal management module difficult and therefore unnecessarily expensive.

The object of the invention is to therefore create a better assembly containing a compressor and the aforementioned thermal management module, with which the above problems are at least partially, ideally entirely, resolved.

This is achieved with the subject matter of the independent Numbered Paragraphs. Preferred embodiments are the subject matter of the dependent Numbered Paragraphs.

The fundamental concept of the invention is to therefore preassemble the above assembly, comprising a compressor and a thermal management module, on a single mount, such that the compressor, thermal management module, and mount can be installed in the vehicle as a unit. This simplifies the installation of the compressor and thermal management module in the vehicle. This also reduces assembly costs.

The above assembly for a vehicle therefore comprises a thermal management module with a preferably closed refrigerant circuit. There are at least two heat exchangers in the refrigerant circuit for exchanging heat between the refrigerant and a separate coolant flowing through the heat exchangers. The coolant circulates in a separate coolant circuit in which the two heat exchangers are also located. The refrigerant circuit and coolant circuit are therefore thermally coupled in the heat exchangers in the thermal management module. The first heat exchanger can be a condenser in which the refrigerant is condensed. The heat that is released can then be transferred to the coolant. The second heat exchanger can be a chiller in which the refrigerant is vaporized. The heat needed for this is obtained from the coolant. The two heat exchangers can thus be used to control the temperature of the coolant. The thermal management module can also contain a reservoir for the refrigerant that can be incorporated in the refrigerant circuit. The thermal management module can also contain an expansion element, e.g. an expansion valve, which is also incorporated in the refrigerant circuit.

The assembly also contains a compressor with a housing in which the refrigerant can be pressurized. The compressor has a housing with an interior through which the refrigerant flows. The housing can contain a compressor unit for pressurizing the refrigerant.

The compressor therefore forms a pressurizer, the expansion valve forms an expansion element, and the two heat exchangers form a condenser and an evaporator for the refrigerant circuit.

The coolant circuit can be thermally coupled to various vehicle components that need cooling. The thermal management module can contain fluid lines for this, which are part of the coolant circuit through which coolant flows, separately from the refrigerant. These lines can be formed in a fluid-conducting element in the thermal management module, with ports to which other functional components of the thermal management module can be attached, e.g. sensors, pumps, or valves, such that the fluid-conducting element can also function as a mount for these functional components.

The assembly also has a mount to which both the compressor and the thermal management module are attached, such that the mount can be installed in the motor vehicle, with the compressor and thermal management module, as a unit.

This mount preferably comprises at least two parts, a main mount and a secondary mount spaced apart therefrom. This simplifies the attachment of the compressor and thermal management module to the mount when assembling the assembly.

The thermal management module can also contain a refrigerant distributer with at least two fluid paths for the refrigerant. The refrigerant distributer is therefore part of the refrigerant circuit.

The main mount can be connected to the secondary mount by the refrigerant distributor. The refrigerant distributor can therefore function as a mechanical reinforcement, giving the assembly the necessary rigidity for use in a motor vehicle. The main and secondary mounts can be attached to the refrigerant distributer with at least two threaded fasteners. This forms a simple means of attaching the two mounts to the refrigerant distributer when assembling the assembly.

The main mount can have a first leg that transitions to a second leg that is orthogonal thereto. In this case, the compressor is attached to both legs of the main mount. This results in a particularly robust support for the relatively heavy compressor. The two legs can formed a single, integral element. Consequently, the mount can be produced easily and inexpensively.

There are at least two, preferably three damping elements on the mount, with which the mount is attached to the vehicle at attachment points intended for this. This protects the components on the mount, specifically the compressor and thermal management module, from external mechanical effects such as impacts and collisions that the vehicle may be subjected to. The compressor could also be attached directly to the mount, without damping elements. This reduces production costs.

The mount is preferably made of a plastic, ideally polypropylene or PA6/6 containing glass fibers. This reduces production costs for the mount.

The invention also relates to a motor vehicle, in particular an electric vehicle with a frame. This vehicle also contains the above assembly, such that the advantages obtained therewith also apply to the vehicle. The mount for the assembly is releasably attached to the vehicle frame, preferably with at least one threaded fastener.

The invention also relates to a method for installing the above assembly. The advantages obtained with the assembly therefore apply to the vehicle. This method comprises at least two steps, a) and b). In the first step a), the compressor and thermal management module, with the refrigerant circuit, are placed on the mount. In the second step b), the assembly obtained in step a) is installed as a unit in the vehicle. Step b) therefore takes place after step a).

Prior to step b), the refrigerant circuit can be filled with refrigerant. Consequently, the refrigerant circuit is already ready for use, prior to being installed in the vehicle. This eliminates subsequent filling of the refrigerant circuit after installing the assembly in the vehicle, making installation less difficult and reducing costs.

The invention also relates to a motor vehicle with a frame and the above assembly, such that the advantages obtained with the assembly also apply to the motor vehicle. The mount for the assembly is preferably releasably attached to the vehicle frame with at least one threaded fastener. The vehicle preferably has a separate coolant circuit that is thermally coupled to the refrigerant circuit in the heat exchangers in the thermal management module. The vehicle also contains at least one component that can be cooled by the coolant. The vehicle can also contain an interior that can also be cooled by the coolant.

Other important features and advantages of the invention can be derived from the dependent claims, drawings, and descriptions of the drawings.

The features specified above and explained below can be used not only in the given combinations, but also in other combinations or in and of themselves, without abandoning the scope of protection for the invention.

Preferred exemplary embodiments of the invention are shown in the drawings and shall be explained in greater detail below, in which the same reference symbols are used for the same, similar, or functionally identical components.

Therein, schematically:

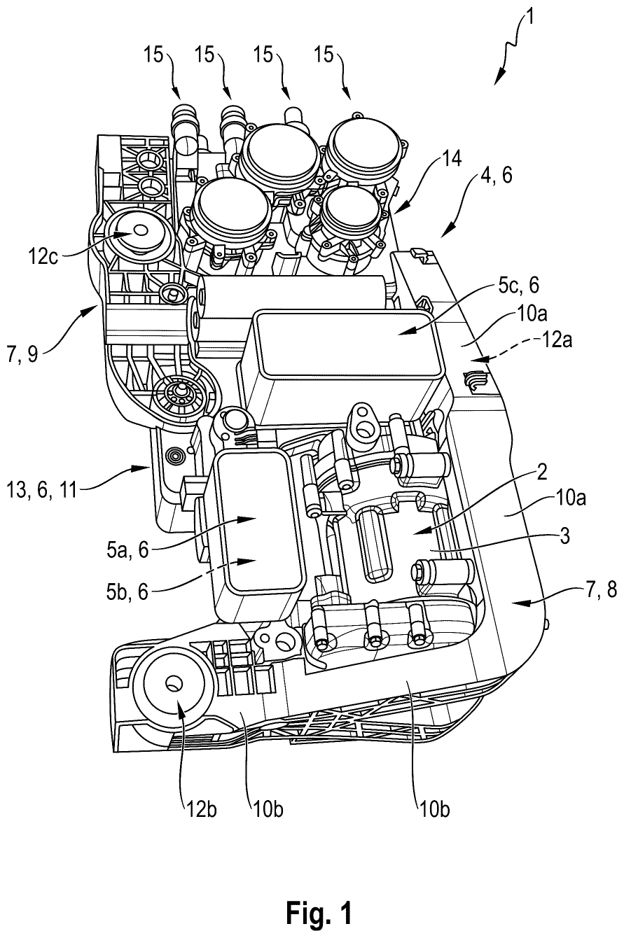

FIG. 1 shows an example of the assembly obtained with the invention, in a perspective view,

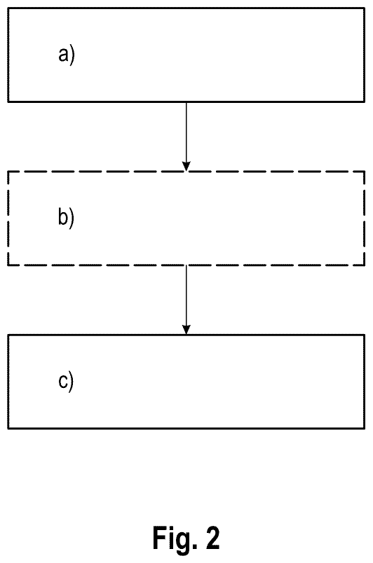

FIG. 2 shows a flow chart for the method obtained with the invention.

FIG. 1 is an exemplary perspective illustration of the assembly 1 for a motor vehicle obtained with the invention. The assembly 1 contains a thermal management module 4 with a closed refrigerant circuit 6. The thermal management module 4 also contains two heat exchangers 5a, 5b in the refrigerant circuit 6 for exchanging heat between the refrigerant and a separate coolant conducted through the heat exchangers 5a, 5b.

The coolant can circulate in a separate coolant circuit (not shown), in which the two heat exchangers 5a, 5b are located. The thermal coupling of the refrigerant circuit 6 to the coolant circuit takes place in the two heat exchangers 5a, 5b. The first heat exchanger 5a can be seen clearly in FIG. 1, but the second heat exchanger 5b is concealed. This thermal management module 4 also contains a third heat exchanger 5c.

The first heat exchanger 5a can be a condenser in which the refrigerant is condensed. The heat that is released thereby can be transferred in the heat exchanger 5s to the coolant. The second heat exchanger 5b can be a chiller, in which the refrigerant is vaporized. The heat needed for this is obtained from the coolant in the heat exchanger 5b. The two heat exchangers 5a, 5b can therefore control the temperature of the coolant, i.e. heating or cooling it. The coolant circuit can be thermally coupled to numerous vehicle components that need to be cooled. The coolant circuit can also be thermally coupled to the vehicle interior in order to cool it.

The thermal management module 4 can contain fluid lines that are part of the coolant circuit, which is separate from the refrigerant circuit. These lines can be formed in a fluid-conducting element 14 in the thermal management module 4, to which other functional components (not shown) in the thermal management module 4 can be attached, e.g. sensors, pumps, or valves, such that the fluid-conducting element also functions as a mount for these components. There can be ports 15 on the fluid-conducting element 14 for these components, into which the fluid lines open.

The assembly 1 in FIG. 1 also contains a compressor 2 for pressurizing the refrigerant. This compressor 2 is in the refrigerant circuit 6. The compressor 2 has a housing 3 with an interior through which the refrigerant flows. There can be a compressor unit in the housing for pressurizing the refrigerant.

The thermal management module 4 can also contain an expansion element (not shown) in the refrigerant circuit 6, e.g. an expansion valve. The compressor 2 functions as a pressurizer, the expansion valve as an expansion element, and the heat exchangers 5a, 5b form a condenser and vaporizer in the refrigerant circuit.

This thermal management module 4 also contains a refrigerant distributor 13 with numerous fluid paths for the refrigerant. The refrigerant distributor 13 is part of the refrigerant circuit 6. Consequently, the refrigerant distributor 13 is connected to the two heat exchangers 5a, 5b.

The assembly 1 also has a mount 7 to which both the compressor 2 and the thermal management module 4 are attached. The mount 7 can therefore by installed in the vehicle, with the compressor 2 and the thermal management module 4, as a unit.

As FIG. 1 shows, the mount 7 comprises two parts, the main mount 8 and a separate secondary mount 9. The main mount 8 has a first leg 31a that transitions to a second leg 10b, which is orthogonal to the first leg 10a. The compressor 2, or its housing 3, can be attached to the first leg 10a and the second leg 10b.

The main mount 8 is preferably connected to the secondary mount 9 by the refrigerant distributor 13. In this case, the refrigerant distributor 13 functions as a reinforcement 11, giving the assembly, comprising the main mount, secondary mount, and components of the thermal management module 4, the necessary mechanical rigidity. The main mount 8 and secondary mount 9 can each be attached to the refrigerant distributor by at least two threaded fasteners (not shown).

The main mount 8 can have two damping elements 12a, 12b (the first of which is concealed behind the first leg 10a in FIG. 1), with which the mount 7 can be attached to the vehicle at attachment points intended for this. There can be a third damping element 12c on the secondary mount 9 with which it is attached to the vehicle at the attachment point intended for this. These attachment points can be formed on the vehicle frame. The main mount 8 and secondary mount 9 are made of plastic in this example, e.g. polypropylene or PA6/6 containing glass fibers. These mounts 8, 9 can also be plastic injection-molded parts.

The fluid-conducting element 14 is attached to the secondary mount 9 in this example.

The method for installing the assembly 1 in a vehicle shall be explained below in reference to the flow chart in FIG. 2.

As the flow chart indicates, this method can contain three steps, a), a1), and b). The two steps a) and b) are obligatory, the other step a1) is optional.

The compressor 2 and thermal management module 4 with the refrigerant circuit 6 are (pre)placed on the mount 7 in the first step a). The compressor 1, the thermal management module 4 with the refrigerant circuit 6, and the mount 7 thus form a structural unit.

The refrigerant circuit is filled with refrigerant in the second step a1).

The structural unit obtained in steps a) and a1) is then installed in the motor vehicle in step b).

Step a1) therefore takes place before step b), i.e. the refrigerant circuit 6 is filled with refrigerant before the assembly 1 is installed in the vehicle.

This method eliminates the relatively complicated filling of the refrigerant circuit 6 after the assembly 1 with the thermal management module 4 has been installed in the vehicle.

The specification can be readily understood with reference to the following Numbered Paragraphs:
Numbered Paragraph 1. An assembly (1) for a motor vehicle, in particular a battery-powered electric vehicle, which has
   a thermal management module (4) with a refrigerant circuit (6) in which there are at least two heat exchangers (5a, 5b) for exchanging heat between the refrigerant and a separate coolant conducted therethrough,
   a compressor (2) with a housing (3) for pressurizing the refrigerant, and
   a mount (7) to which the compressor (2) and the thermal management module (4) are attached, such that the mount (7), along with the compressor (2) and thermal management module (4) form a structural unit that can be installed in the vehicle.
Numbered Paragraph 2. The assembly according to Numbered Paragraph 1, characterized in that the mount (7) comprises two parts, a main mount (8) and a separate secondary mount (9) at a spacing thereto.
Numbered Paragraph 3. The assembly according to Numbered Paragraph 1 or 2, characterized in that the thermal management module (4) contains a refrigerant distributor (13) with at least two fluid paths for the refrigerant, and the refrigerant distributor (13) is part of the refrigerant circuit (6).
Numbered Paragraph 4. The assembly according to Numbered Paragraph 3, characterized in that the main mount (8) is connected to the secondary mount (9) by the refrigerant distributor (13), such that the refrigerant distributor (13) functions as a reinforcement (11), and preferably both the main mount (8) and the secondary mount (8) are each attached to the refrigerant distributer (13) by at least two threaded fasteners.
Numbered Paragraph 5. The assembly according to Numbered Paragraph 3 or 4, characterized in that the main mount (8) has a first leg (10a) that transitions to a second leg (10b), which is orthogonal to the first, and the compressor (2) is attached to both the first leg (10a) and the second leg (10b).
Numbered Paragraph 6. The assembly according to any of the preceding Numbered Paragraphs, characterized in that there are at least two, preferably three, damping elements (12a-12c) on the mount (7), with which the mount (7) can be attached to the vehicle at attachment points intended for this.
Numbered Paragraph 7. The assembly according to any of the Numbered Paragraphs 1 to 6, characterized in that the compressor (2) is attached directly to the mount (7), without damping elements.
Numbered Paragraph 8. The assembly according to any of the preceding Numbered Paragraphs, characterized in that the mount (7), preferably the main mount (8) and/or secondary mount (9), are made of plastic, preferably polypropylene or PA6/6 containing glass fibers.
Numbered Paragraph 9. The assembly according to any of the preceding Numbered Paragraphs, characterized in that the thermal management module (4) contains a fluid-conducting element (14) with numerous fluid paths through which a coolant can flow separately from the refrigerant circuit.
Numbered Paragraph 10. A motor vehicle (20), in particular an electric vehicle, which has
   a frame (21), and
   an assembly (1) according to any of the preceding Numbered Paragraphs, the mount (7) for which is preferably releasably attached to the frame (21) by threaded fasteners.
Numbered Paragraph 11. A method for installing an assembly (1) according to any of the Numbered Paragraphs 1 to 10 in a motor vehicle (20), comprising the following steps:
   a) placing the compressor (1) and thermal management module (4) with the refrigerant circuit (6) on the mount (7),
   b) installing the assembly (1) obtained in step a) in the vehicle.
Numbered Paragraph 12. The method according to Numbered Paragraph 11, characterized in that the refrigerant circuit (6) in the thermal management module (4) is filled with refrigerant in an additional step a1), prior to step b).

### LIST OF REFERENCE SYMBOLS

1 assembly
2 compressor
3 compressor housing
4 thermal management module
5a,b first and second heat exchangers
6 refrigerant circuit
7 mount
8 main mount
9 secondary mount
10a,b first and second legs
11 reinforcement
12a-c damping elements
13 refrigerant distributor
14 fluid-conducting element
15 ports

1-12. (canceled)

13. An assembly for a battery-powered electric vehicle, comprising a thermal management module with a refrigerant circuit in which there are at least two heat exchangers configured for exchanging heat between the refrigerant and a separate coolant conducted therethrough,
a compressor with a housing when in operation configured for pressurizing the refrigerant, and
a mount to which the compressor and the thermal management module are attached, such that the mount, along with the compressor and thermal management module form a structural unit that is configured be installed in the vehicle.

14. The assembly according to claim 13, wherein the mount comprises two parts, a main mount and a separate secondary mount disposed with a spacing between the main mount and the separate secondary mount.

15. The assembly according to claim 13, wherein the thermal management module comprises a refrigerant distributor with at least two fluid paths for the refrigerant, and the refrigerant distributor is part of the refrigerant circuit.

16. The assembly according to claim 14, wherein the main mount is connected to the secondary mount by the refrigerant distributor, such that the refrigerant distributor functions as a reinforcement, wherein the main mount and the secondary mount are each attached to the refrigerant distributer by at least two threaded fasteners.

17. The assembly according to claim 15, wherein the main mount comprises a first leg that transitions to a second leg, which is orthogonal to the first, and the compressor is attached to both the first leg and the second leg.

18. The assembly according to claim 13, further comprising three damping elements on the mount, with which the mount can be attached to the vehicle at attachment points in engagement with the three damping elements.

19. The assembly according to claim 13, wherein the compressor is attached directly to the mount, without damping elements.

20. The assembly according to claim 13, wherein the one or both of the main mount or the secondary mount are made of plastic, preferably polypropylene or PA6/6 containing glass fibers.

21. The assembly according to claim 13, wherein the thermal management module comprises a fluid-conducting element with a plurality of fluid paths through which a coolant can flow separately from the refrigerant circuit.

22. An electric motor vehicle, comprising a frame, and
an assembly according to claim 13, the mount is releasably attached to the
frame by threaded fasteners.

23. A method for installing an assembly according to claim 13 in a motor vehicle, comprising the following steps:
a) placing the compressor and thermal management module with the refrigerant circuit on the mount,
b) installing the assembly obtained in step a) in the vehicle.

24. The method according to claim 23, further comprising filling the thermal management module with refrigerant in an additional step a1), prior to step b).

25. The assembly according to claim 20, wherein the one or both of the main mount or the secondary mount are made polypropylene or PA6/6 containing glass fibers.
